(19) United States
(12) Patent Application Publication
(10) Pub. No.: US 2009/0131557 A1
(43) Pub. Date: May 21, 2009

(54) SHAPE MEMORY RESIN

(76) Inventors: Hiroshi Uyama, Osaka (JP); Hiroshi Kageyama, Osaka (JP); Takashi Tsujimoto, Osaka (JP)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/298,540

(22) PCT Filed: Apr. 26, 2007
(86) PCT No.: PCT/JP07/59442

§ 371 Date: Oct. 27, 2008

(30) Foreign Application Priority Data
May 2, 2006 (JP) 2006-128113

(51) Int. Cl. C08L 63/02; C08L 67/00; C08L 27/06

(52) U.S. Cl. 523/400; 525/50; 525/523; 525/415; 525/55; 524/500; 524/502; 524/539

(57) ABSTRACT

A shape memory resin of the present invention contains a network polymer and a thermoplastic polymer, and the thermoplastic polymer is dissolved in the network polymer. The shape memory resin of the present invention can be produced by a simple process of simply dissolving the thermoplastic polymer in a network polymer precursor and cross-linking this network polymer precursor. In the present invention, an epoxy compound is preferably used as the network polymer precursor.

### TECHNICAL FIELD

The present invention relates to a shape memory resin and a method for producing the same.

### BACKGROUND ART

In order to address resource conservation, energy conservation, environmental issues, and the like, development of intelligent functional materials and application of those materials to mechanical systems have been expected. Shape memory materials are among important intelligent functional materials and have been put to practical use in metals and polymers. For example, an “easy-to-disassemble screw” that loses the screw threads when heated and becomes easily disassembable, a “shape memory spoon” that has a deformable handle that is deformed into a shape easily used even by a person with hand disability, or the like is practically used. Furthermore, the shape memory materials are also applied to intravenous indwelling needles, catheters, and the like in the medical field.

The shape memory materials show their functional properties based on phase transformation caused by a change in the crystalline structure or a change in the mode of molecular motion. A shape memory material is fixed to a temporary form when a shape is programmed, and recovers its original shape when an external stimulus is provided. In order to create a highly functional shape memory material, it is necessary to design and develop a freely programmable material, and for this purpose, precise structure control of the material at a molecular level is required.

Shape memory polymers exert their function based on a change in the motion of macromolecular chains caused by a phase transition, and in many cases, phase transitions at a melting point and a glass transition temperature are used to exert their function. Generally, a shape memory polymer is constituted by a switch portion and a hard portion, and a network structure is formed in the polymer by fixing a phase transition phenomenon of the switch portion with the hard portion to maintain the form of the shape memory polymer as a material.

Materials in which the hard portion is physically cross-linked, a representative example of which is polyurethanes, have been frequently used as the shape memory polymers in view of easy moldability (Japanese Laid-Open Patent Publication Nos. 2004-300368 and 2005-325336 and WO 99/42528). In the shape memory polymers, a hard segment containing a urethane bond serves as the hard portion, and a change in the modulus of elasticity of a soft segment of polyurethanes at the glass transition temperature is used for shape programming. Although it is more advantageous to use a phase transition at the melting point because a wider range of change in shape can be achieved, in the case where the hard portion is physically cross-linked, the form of macromolecular chains cannot be maintained due to melting of the polymers, and consequently the glass transition temperature has to be used. Thus, it is difficult to achieve a large deformation and a quick change in form. On the other hand, in the case of shape memory polymers utilizing melting, the hard portion is often chemically cross-linked; however, chemically cross-linked gels have poor moldability and have not yet resulted in development of a practical material. In either case, since a conventional shape memory polymer has the switch portion and the hard portion within the same polymer molecule, a meticulous molecular design and a complicated synthesis operation are needed.

### DISCLOSURE OF INVENTION

It is an object of the present invention to provide a novel shape memory resin that can be produced in a simpler manner and the material properties of which can be freely adjusted in accordance with the intended purpose.

In the present invention, a shape memory resin based on a molecular design different from those of conventional types has been developed by using a phase transition of a thermoplastic polymer in a blend of a network polymer and the thermoplastic polymer.

The present invention provides a shape memory resin comprising a network polymer and a thermoplastic polymer,

wherein the thermoplastic polymer has compatibility with a network polymer precursor and is dispersed in the network polymer.

The present invention also provides a method for producing a shape memory resin, the method comprises:

dissolving a thermoplastic polymer in a network polymer precursor to obtain a mixture; and

adding a hardener to the mixture to cross-link the network polymer precursor,

wherein the thermoplastic polymer has compatibility with the network polymer precursor.

In a certain embodiment, the network polymer precursor is an epoxy compound.

In one embodiment, the epoxy compound is at least one selected from the group consisting of an epoxidized fat or oil and an epoxy resin.

In a further embodiment, the epoxidized fat or oil is at least one selected from the group consisting of epoxidized soybean oil, epoxidized linseed oil, and epoxidized palm oil, and the epoxy resin is a bisphenol A type epoxy resin.

In a certain embodiment, the thermoplastic polymer is at least one selected from the group consisting of polycaprolactone, polyvinyl chloride, polylactic acid, and poly(butylene succinate).

In one embodiment, the glass transition temperature or the melting point of the thermoplastic polymer is different from the glass transition temperature of the network polymer by at least 20° C.

In the shape memory resin of the present invention, an amorphous network polymer is used as a matrix, and a thermoplastic polymer chain is fixed in this matrix at a molecular level. Thus, the shape memory function can be exerted by using as an output a macroscopic change in the form of the phase transition polymer (or thermoplastic polymer) in the network. The shape memory resin of the present invention can be produced by a very simple method in which the thermoplastic polymer is dissolved in a network polymer precursor (e.g., an epoxy compound), and curing is performed at a temperature equal to or above the phase transition temperature of the thermoplastic polymer. Therefore, the present invention can be easily applied to combinations of a wide range of resins.

### BRIEF DESCRIPTION OF THE DRAWINGS

FIG. 1 shows photographs showing the shape of a flat plate-like sample molded by using ESO/PCL=50/50 (the Mn of the PCL=80000), where FIG. 1A is a photograph showing a loop-like shape (deformed shape) of the flat plate-like sample that is deformed by applying heat, and FIG. 1B is a photograph showing the shape (recovered shape) of the flat plate-like sample that is recovered by soaking the sample having the loop-like shape in hot water. Note that ESO represents epoxidized soybean oil and PCL represents polycaprolactone.

FIG. 2 is a graph showing the relationship between the strain and the tensile stress in a uniaxial stretching test with respect to a flat plate-like sample molded by using ESO/PCL=50/50 (the Mn of the PCL=80000) and a polyurethane.

FIG. 3 is a graph showing the relationship between the strain and the tensile stress in a uniaxial stretching test with respect to flat plate-like samples molded by using ESO/BPAEP/PCL in various ratios. Note that BPAEP represents bisphenol A diglycidyl ether.

FIG. 4 is a graph showing a DSC curve of a flat plate-like sample molded by using ESO/PCL/PBS=1/1/1 (the Mn of the PCL=80000). Note that PBS represents poly(butylene succinate).

FIG. 5 shows photographs showing the shape of the flat plate-like sample molded by using ESO/PCL/PBS=1/1/1 (the Mn of the PCL=80000) during a shape memory process from a molded shape to a deformed shape.

FIG. 6 shows photographs showing the shape of the flat plate-like sample molded by using ESO/PCL/PBS=1/1/1 (the Mn of the PCL=80000) during a shape recovery process from the deformed shape to the molded shape.

FIG. 7 shows photographs showing the shape of a helical sample molded by using ESO/PCL/PVC=1/1/1 (the Mn of the PCL=80000) during a shape memory process from a molded shape to a deformed shape. Note that PVC represents polyvinyl chloride.

FIG. 8 shows photographs showing the shape of the helical sample molded by using ESO/PCL/PVC=1/1/1 (the Mn of the PCL=80000) during a shape recovery process from the deformed shape to the molded shape.

FIG. 9 shows photographs showing the shape of loop-like samples molded by using ESO/PCL/PVC=1/1/1 or 1/1/2 (the Mn of the PCL=80000) during a shape memory process from a molded shape to a deformed shape and a corresponding shape recovery process.

### BEST MODE FOR CARRYING OUT THE INVENTION

A shape memory resin is a resin that can be switched between a molded shape and a deformed shape by manipulating the temperature with heat. A conventional shape memory resin is fixed to a deformed shape by deforming the shape memory resin at a temperature equal to or above the glass transition temperature (Tg) and below the melting temperature or below the degradation temperature of the shape memory resin itself and cooling the deformed shape memory resin to the glass transition temperature or below while maintaining the deformed shape. Then, the shape memory resin is recovered to its original shape by heating the shape memory resin to a temperature equal to or above the glass transition temperature and below the melting temperature or below the degradation temperature. In contrast, in the shape memory resin of the present invention, a thermoplastic polymer is dispersed in a matrix polymer (i.e., the network polymer) having a relatively large temperature difference from the Tg or the melting point of the thermoplastic polymer (e.g., having a relatively low Tg), and the shape memory function is exerted by using a phase transition of the thermoplastic polymer at the Tg or the melting point.

In the present invention, the network polymer refers to a polymer formed by cross-linking a network polymer precursor and has a three-dimensional network structure. Furthermore, in the present invention, the network polymer precursor refers to a polymer that can form a network by cross-linking.

Examples of the network polymer precursor used in the present invention include epoxy compounds, phenolic resins, acrylic resins, unsaturated polyesters, melamine resins, and urea resins. The network polymer precursors may be used alone or in combination as a mixture of two or more. In the present invention, the epoxy compounds are preferably used because of the ease of handling and the good moldability.

There is no particular limitation regarding the epoxy compounds used in the present invention as long as the epoxy compounds are epoxy resins or epoxides of triglycerides containing an unsaturated group (i.e., epoxidized fats and oils).

Examples of the epoxy resins include bisphenol A type epoxy resins (e.g., bisphenol A diglycidyl ethers), novolac-type epoxy resins, and glycidyl ester type epoxy resins. Epoxy resins commercially available for industrial use may be used as these epoxy resins. Representative examples of such commercially available epoxy resins include various kinds of Epikotes®.

There is no particular limitation regarding the epoxidized fats and oils (the epoxides of triglycerides containing an unsaturated group) as long as the epoxidized fats and oils are epoxides of resins having, as the main component, triglycerides containing an unsaturated fatty acid in the fatty acid component. For example, epoxides of natural triglycerides can be used. Examples of the natural triglycerides (natural fats and oils) include soybean oil, linseed oil, fish oil, sunflower oil, tung oil, castor oil, corn oil, rapeseed oil, sesame oil, olive oil, palm oil, and grape seed oil. Examples of the fatty acid component in such fats and oils include saturated fatty acids ranging from butyric acid having 4 carbon atoms to lignoceric acid having 24 carbon atoms as well as corresponding unsaturated fatty acids, and typical saturated fatty acids are palmitic acid and stearic acid and typical unsaturated fatty acids are oleic acid, linoleic acid, and linolenic acid. In order to efficiently promote the network formation of the epoxy compounds by a curing (cross-linking) reaction, triglycerides preferably have a high degree of unsaturation, preferably have saturated fatty acids in the fatty acid component in a low ratio, and preferably have a high epoxy group content when the triglycerides become epoxy compounds. In these respects, soybean oil (e.g., the percentage of saturated fatty acids in the fatty acid component is not more than 20%), linseed oil, and palm oil (e.g., the percentage of saturated fatty acids in the fatty acid component is not more than 50%) are preferable. Examples of commercially available epoxidized fats and oils include an epoxidized linseed oil (product name: DAIMAC L-500) and an epoxidized soybean oil (product name: DAIMAC S-300K) from Daicel Chemical Industries, Ltd., and an epoxidized soybean oil (product name: KAPOX S-6) from Kao Corporation. It should be noted that natural fats and oils may contain small amounts of free fatty acids, complex lipids, unsaponifiable matters, and the like in addition to the above-described triglycerides, and the content of those components other than the triglycerides is generally not more than 5 wt %.

The above-described epoxidized fats and oils are obtained by epoxidizing the unsaturated portion of unsaturated fatty acids of triglycerides, that is, by oxidatively converting a carbon-carbon double bond to 1,2-epoxide (oxirane). To efficiently promote the curing (cross-linking) reaction, an epoxidation ratio in which the unsaturated portion is epoxidized is preferably high, and the epoxidation ratio is preferably 50 to 100% and more preferably 70 to 100%. In the cases where the epoxidation ratio is less than 50%, a network with a high degree of cross-linking is not formed, and thus the shape of shape memory resin molded products tends to be poorly maintained. Moreover, when a large amount of double bonds that are not epoxidized remains in the triglycerides, there is a possibility that deterioration of the shape memory resins may be accelerated by an oxidation of the remaining double bonds.

The above-described epoxy compounds may be used alone or in combination as a mixture of two or more. Epoxy compounds that are in liquid form at room temperature are preferable in that the thermoplastic polymer is easily dissolved therein.

There is no particular limitation regarding the thermoplastic polymer used in the present invention as long as the thermoplastic polymer has compatibility with the network polymer precursor, and the thermoplastic polymer can be appropriately selected in accordance with the network polymer precursor. Here, the “compatibility” means that two or more different substances have affinity for each other and form a solution or a miscible system. In the present invention, a thermoplastic polymer is considered to have compatibility with the network polymer precursor if a solution or a miscible system is formed to a visually observable extent. The thermoplastic polymer used in the present invention may be either of a crystalline polymer or an amorphous polymer.

Examples of such a thermoplastic polymer include polycaprolactone, polyvinyl chloride, polylactic acid, polystyrene, acrylic resin, polysulfone, polyvinyl acetate, polyphenylene oxide, polyethylene oxide, polypropylene glycol, poly(hydroxyalkanoate), poly(ethylene succinate), poly(butylene succinate), polycarbonate, poly(oxytetraethylene), polyethylene, polypropylene, polyethylene terephthalate (PET), polybutylene terephthalate (PBT), nylon, and polyphenylene sulfide (PPS). For example, in the case where the network polymer precursor is an epoxy compound, polycaprolactone, polyvinyl chloride, polylactic acid, and poly(butylene succinate) are preferable in that they have good compatibility with this network polymer precursor. These thermoplastic polymers may be used alone or in combination as a mixture of two or more.

It is preferred that the thermoplastic polymer used in the present invention has a higher molecular weight in view of the maintenance of the shape of a molded product. For example, in the case of polycaprolactone, the number average molecular weight (Mn) can be preferably at least 10000, more preferably at least 30000, and even more preferably at least 50000. There is no particular limitation regarding the upper limit of the molecular weight of the thermoplastic polymer as long as the thermoplastic polymer has compatibility with the network polymer precursor to be used. It should be noted that the suitable molecular weight of the thermoplastic polymer may vary depending on the type of the above-described network polymer precursor and the mixing ratio.

Furthermore, it is preferable that the glass transition temperature (Tg) or the melting point of the thermoplastic polymer is different from the Tg of the network polymer by at least 20° C., because the shape can be definitely controlled between the molded shape and the deformed shape. For example, if a plurality of thermoplastic polymers having a difference in the melting point of 20° C. or more from each other are used and the network polymer precursor is subjected to a curing reaction in the presence of the plurality of polymers, then a shape memory resin that is deformable in a plurality of stages can also be obtained.

The mixing ratio of the network polymer precursor to the thermoplastic polymer varies depending on the types of the network polymer precursor and the thermoplastic polymer to be used. The mixing ratio in terms of weight of the network polymer precursor to the thermoplastic polymer is usually 10:90 to 90:10, preferably 20:80 to 80:20, and more preferably 25:75 to 75:25. If the ratio of the network polymer precursor is too high, then the deformability tends to be poor, and if the ratio of the network polymer precursor is too low, then the shape tends to be poorly maintained.

In order to cross-link the network polymer precursor to form the network polymer, a hardener (i.e., a cross-linking agent or a catalyst) is needed. The type and amount of the hardener can be appropriately selected by those skilled in the art in accordance with the type of the network polymer precursor.

For example, in the case where the network polymer precursor is an epoxy compound, it is preferable to use an acid catalyst as the hardener for subjecting an epoxy group in the epoxy compound to ring-opening polymerization. When a conventional acid catalyst is used, the cross-linking reaction starts before a heat-curing treatment, and thus it tends to be difficult to obtain a shape memory resin having a uniform composition. For this reason, a thermal latent acid catalyst is preferably used. The thermal latent acid catalyst does not function as a catalyst at a predetermined temperature or below, but at higher temperature than the predetermined temperature, the thermal latent acid catalyst degrades to generate an acid and exerts a catalytic action. When a thermal latent catalyst is used, a shape memory resin having a uniform composition can be obtained, for example, by sufficiently mixing the epoxy compound and the thermoplastic polymer at an ordinary temperature and subsequently raising the temperature to cause a polymerization reaction. Alternatively, a photo-curing catalyst may also be used as the hardener.

Any known thermal latent acid catalysts can be used as the thermal latent acid catalyst. The thermal latent acid catalysts are described in, for example, “Current Advancement of Photo Functional Polymeric Materials” (supervised by Kunihiro Ichimura, CMC Publishing Co., Ltd., 2002), Chapter 1, “Photo- and Thermal-Latent Cationic and Anionic Polymerization Catalysts”, and specific examples thereof include aromatic sulfonium salts (e.g., benzyl sulfonium salts), benzyl ammonium salts, and benzyl phosphonium salts. If the temperature at which the thermal latent acid catalyst degrades to generate an acid is too low, then the cross-linking reaction starts before the heat-curing treatment, and thus a uniform network polymer is unlikely to be formed, and if this temperature is too high, then the components of a mixture of the epoxy compound and the thermoplastic polymer may be easily volatilized and degraded. Therefore, the temperature at which the thermal latent acid catalyst degrades to generate an acid is preferably 50 to 250° C. and particularly preferably 80 to 180° C.

In the case where the network polymer precursor is an epoxy compound, the amount of the hardener to be added is preferably 0.1 to 20 parts by weight and particularly preferably 0.3 to 10 parts by weight with respect to 100 parts by weight of the epoxy compound. If the amount is less than 0.1 parts by weight, then the cross-linking reaction of the epoxy compound does not tend to be sufficiently completed, and if the amount is more than 20 parts by weight, then the cross-linking tends to be nonuniform.

The method for producing a shape memory resin of the present invention includes the steps of dissolving the above-described thermoplastic polymer in the above-described network polymer precursor to obtain a mixture; and adding a hardener to the mixture to cross-link the network polymer precursor.

The step of mixing the network polymer precursor and the thermoplastic polymer is usually performed at room temperature. As necessary, heat may be applied, or ultrasonic waves may be used to accelerate the mixing. Alternatively, a volatile organic solvent may be added to accelerate the mixing.

Next, the hardener is added to and mixed well with the mixture of the network polymer precursor and the thermoplastic polymer. The resultant mixture is, for example, poured into a mold or the like, so that the network polymer precursor is cross-linked and molded at the same time. The molding method used in the present invention can be appropriately selected by those skilled in the art in accordance with the types and the mixing ratio of the network polymer precursor and the thermoplastic polymer, the desired shape of the molded product, and the like. Examples of the molding method include casting, injection molding, and dip molding.

The conditions of the heat treatment for cross-linking the network polymer precursor in the mixture are selected in accordance with the type of the hardener to be used. Preferably, the temperature is selected within the range of from 50 to 250° C. (more preferably from 80 to 180° C.). If the temperature of the heat treatment is less than 50° C., then the cross-linking reaction does not tend to sufficiently proceed. On the other hand, if this temperature is more than 250° C., then the network polymer precursor may be volatilized and degraded, and thus a good shape memory resin is unlikely to be obtained. There is no particular limitation regarding the reaction time required for the heat treatment. The reaction time is preferably about 10 minutes to 24 hours and more preferably about 30 minutes to 4 hours. If the reaction time is less than 10 minutes, then the cross-linking reaction does not tend to be sufficiently completed. On the other hand, if the reaction time exceeds 24 hours, then the shape memory resin tends to gradually degrade by heat.

The obtained shape memory resin molded product is warmed to the phase transition temperature (i.e., the Tg or the melting point) of the thermoplastic polymer or above and given a deformed shape (or a temporary shape), and then can be fixed to this deformed shape by rapidly cooling. The molded product having the deformed shape is recovered to the original molded shape by warming again to the phase transition temperature or above.

### EXAMPLES

Hereinafter, the present invention will be described by way of examples. However, it is to be understood that the present invention is not limited by these examples.

### Example 1

First, 50 parts by weight of an epoxidized soybean oil (ESO) (KAPOX S-6: Kao Corporation) and 50 parts by weight of a polycaprolactone (PCL) (Aldrich) having Mn=80000 were mixed well at room temperature, and 1 part by weight of an acid catalyst (San-Aid SI-100L: Sanshin Chemical Industry Co., Ltd.) was added to and further mixed well with this mixture. The resultant mixture was poured into a 44 mm×5 mm×1 mm fluoroplastic mold and heat-treated at 150° C. for 2 hours to obtain a flat plate-like sample (molded shape) having a thickness of about 1 mm. This sample was subjected to differential scanning calorimetry (DSC) (SSC/5200: Seiko Instruments Inc.).

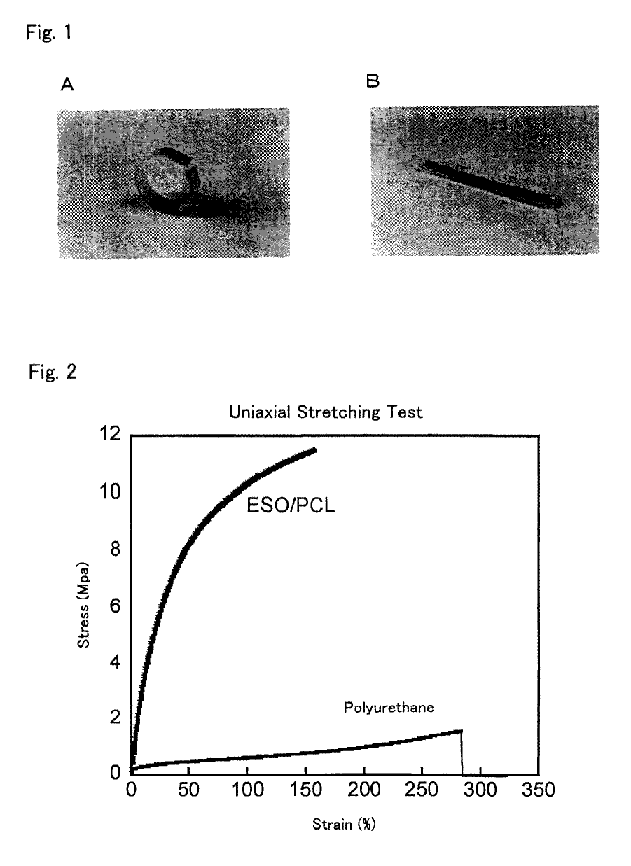

Then, the obtained flat plate-like sample was warmed to 80° C., wrapped around a glass rod having an outer circumferential length of 44 mm, and rapidly cooled to room temperature as it was to give a loop-like sample (deformed shape) (FIG. 1A). The distance between the opposite ends of this loop-like sample was measured. Then, this loop-like sample was soaked in hot water at 90° C. to recover the original shape (FIG. 1B), and the distance between the opposite ends of this recovered shape in the longitudinal direction was measured. This operation was repeated another four times. The results are shown in Table 1.

### Example 2

A sample was obtained in the same manner as in Example 1 except that the PCL was replaced by a PCL (Aldrich) having Mn=42500. The obtained flat plate-like sample (molded shape) had a thickness of about 1.2 mm. The results are shown in Table 1.

### Example 3

A sample was obtained in the same manner as in Example 1 except that the PCL was replaced by a PCL (Aldrich) having Mn=10000. The obtained flat plate-like sample (molded shape) had a thickness of about 1.4 mm. The results are shown in Table 1.

TABLE 1

| | | Example 1 | | Example 2 | | Example 3 | |
|---|---|---|---|---|---|---|---|
| | | Mn = 80000 | | Mn = 42500 | | Mn = 10000 | |
| ESO/PCL = | Number | Deformed | Recovered | Deformed | Recovered | Deformed | Recovered |
| 50/50 | of times | shape | shape | shape | shape | shape | shape |
| Distance | 1 | 1 | 43 | 1 | 43 | 35 | 44 |
| between | 2 | 2 | 43 | 2 | 43 | 36 | 44 |
| opposite | 3 | 2 | 44 | 0 | 44 | 39 | 44 |
| ends of | 4 | 0 | 44 | 1 | 37 | 32 | 44 |
| sample | 5 | 2 | 43 | 2 | 42 | 29 | 44 |
| (mm) | | | | | | | |

| | | | |
|---|---|---|---|
| ΔH (mJ/mg) | 36.1 | 40.6 | 22.1 |

In the samples having ESO/PCL=50/50, when the molecular weight of the PCL was varied from Mn=10000 to 42500 and to 80000, the higher the molecular weight of the PCL, the shorter the distance between the opposite ends of the deformed shape, and the higher the deformability exhibited. Moreover, the ratio of recovery from the deformed shape to the molded shape was high for all of these molecular weights. Furthermore, according to the results of the DSC measurement, the value of ΔH was large and the highest degree of crystallinity was shown in the case where the PCL having Mn=42500 was used, but the deformability exhibited in that case was lower than that in the case where the PCL having Mn=80000 was used. Therefore, it can be considered that the ability to maintain the deformed shape is attributed mainly to the molecular weight rather than the degree of crystallinity of the PCL.

### Example 4

A sample was obtained in the same manner as in Example 1 except that 25 parts by weight of an ESO and 75 parts by weight of a PCL were used and DSC was not performed. The obtained flat plate-like sample (molded shape) had a thickness of about 1 mm. The results are shown in Table 2.

TABLE 2

| ESO/PCL = | Number of | Deformed | Recovered |
|---|---|---|---|
| 25/75 | times | shape | shape |
| Distance | 1 | 1 | 43 |
| between | 2 | 2 | 43 |
| opposite ends | 3 | 0 | 44 |
| of sample | 4 | 1 | 37 |
| (mm) | 5 | 2 | 42 |

In the case of ESO/PCL=25/75, both of the deformability and the recovery ratio were good as in the case of ESO/PCL=50/50 (Example 1).

### Example 5

A sample was obtained in the same manner as in Example 1 except that 75 parts by weight of an ESO and 25 parts by weight of a PCL were used and DSC was not performed. The obtained flat plate-like sample (molded shape) had a thickness of about 0.6 mm. The results are shown in Table 3.

TABLE 3

| ESO/PCL = | Number of | Deformed | Recovered |
|---|---|---|---|
| 75/25 | times | shape | shape |
| Distance | 1 | 35 | 44 |
| between | 2 | 36 | 44 |
| opposite ends | 3 | 39 | 44 |
| of sample | 4 | 32 | 44 |
| (mm) | 5 | 29 | 44 |

In the case of ESO/PCL=75/25, the recovery ratio was good, but the deformability was not very high as compared with the cases of ESO/PCL=50/50 or 25/75.

### Example 6

The same operation as in Example 1 was performed to obtain a flat plate-like sample (ESO/PCL=50/50, the Mn of the PCL=80000). This flat plate-like sample was warmed to 80° C., helically-wrapped around a glass rod having an outer circumferential length of about 20 mm about twice, and rapidly cooled to room temperature as it was to obtain a helical sample. This helical sample was allowed to stand at room temperature, and changes in its shape with time were observed every 10 days until day 30. At room temperature, the helical deformed shape was substantially maintained even after 30 days.

### Example 7

The same operation as in Example 6 was performed to obtain a helical sample. This helical sample was placed on a hot plate at 80° C., and changes in its shape with time were observed. When placed on the hot plate, the windings of the helix immediately started becoming loose, and the flat plate-like molded shape was substantially recovered in about 60 seconds.

### Example 8

The same operation as in Example 1 was performed to obtain a 40 mm×5 mm×1 mm flat plate-like sample (ESO/PCL=50/50, the Mn of the PCL=80000). This ESO/PCL flat plate-like sample was subjected to a uniaxial stretching test in which an EZ Graph (Shimadzu Corporation) was used as a measuring device and the sample was stretched at a rate of 5.0 mm/minute. For comparison, a flat plate-like polyurethane synthesized from an ester polyol and tolylene diisocyanate was also subjected to a uniaxial stretching test. It should be noted that the polyurethane was synthesized in the following manner: 4 parts by weight of a refined castor oil (Itoh Oil Chemicals Co., Ltd.), 1 part by weight of tolylene-2,4-diisocyanate (Tokyo Chemical Industry Co., Ltd.), and 40 parts by weight of chloroform were mixed and stirred at 40° C. for 4 hours. Then, the mixture was poured into a fluoroplastic mold and heated at 140° C. for 15 minutes to obtain the polyurethane.

The results are shown in FIG. 2. As shown in FIG. 2, the ESO/PCL had a very high breaking stress as compared with the polyurethane. Thus, it was found that the ESO/PCL has a high tensile strength.

### Example 9

First, 50 parts by weight of an ESO, 50 parts by weight of a polyvinyl chloride (PVC) (molecular weight of 80000: Aldrich), and 200 parts by weight of chloroform were mixed well at room temperature, and 1 part by weight of an acid catalyst (San-Aid SI-100L: Sanshin Chemical Industry Co., Ltd.) was added to and further mixed well with this mixture. The resultant mixture was poured into a large Teflon® mold, and chloroform was evaporated. Thereafter, a film thus formed was detached from the Teflon® mold and cut to a size of 67 mm×5 mm (thickness: 1 mm). This film was wrapped around a cylindrical glass tube and heated at 150° C. for 2 hours to obtain a loop-like sample (molded shape).

Then, the obtained loop-like sample was warmed to 90° C., the loop was opened until the sample was deformed into a flat plate-like shape, and the deformed sample was then rapidly cooled to room temperature to obtain a flat plate-like sample (deformed shape). The distance between the opposite ends of this flat plate-like sample in the longitudinal direction was measured. Then, this flat plate-like sample was soaked in hot water at 90° C., and the distance between the opposite ends was measured. This operation was repeated another four times. The results are shown in Table 4.

TABLE 4

| ESO/PVC = | Number of | Deformed | Recovered |
|---|---|---|---|
| 50/50 | times | shape | shape |
| Distance | 1 | 67 | 9 |
| between | 2 | 67 | 9 |
| opposite ends | 3 | 67 | 8 |
| of sample | 4 | 67 | 11 |
| (mm) | 5 | 67 | 12 |

The sample that was deformed into the flat plate-like shape immediately recovered the loop-like shape by being soaked in hot water.

### Example 10

An ESO, a polylactic acid (PLLA) (molecular weight of 100000: Shimadzu Corporation), and chloroform (twice the total amount of the ESO and the polylactic acid in terms of part by weight) were mixed well in various ratios indicated in Table 5 below at room temperature, and 1 part by weight (10 μL with respect to 1.0 g of the ESO) of an acid catalyst (San-Aid SI-100L) was added to and further mixed well with these mixtures. The resultant mixtures were applied onto a glass plate using an applicator to form films. Chloroform was evaporated to a certain extent, and thereafter the films thus formed were detached from the glass plate and cut to a size of 85 mm×5 mm (thickness: 0.1 mm). These films were wrapped around a cylindrical glass tube and heated at 150° C. for 2 hours, and thus four loop-like samples (molded shape) of each were obtained.

Then, each of the obtained loop-like samples was warmed, the loop was opened until the sample was deformed into a flat plate-like shape, and the sample was then maintained at 100° C. for 15 minutes. Thereafter, the sample was rapidly cooled in water to obtain a flat plate-like sample (deformed shape). The distance between the opposite ends of this flat plate-like sample was measured. Then, this flat plate-like sample was heated on a hot plate at 100° C. for 3 minutes, and the distance between the opposite ends of the recovered shape was measured. Table 5 shows average values of the results of measurement for the four samples of each.

TABLE 5

| | |
|---|---|
| | Distance between opposite |
| | ends of sample |
| Resin composition | (mm) |

| | | |
|---|---|---|
| (part by weight) | Deformed | Recovered |

| ESO | PLLA | shape | shape |
|---|---|---|---|
| 0 | 100 | 85 | 81 |
| 25 | 75 | 85 | 6 |
| 50 | 50 | 83 | 2 |
| 75 | 25 | 85 | 0.2 |
| 100 | 0 | — | — |

—: unable to be measured

The samples using only the polylactic acid (PLLA) did not recover the original shape after deformation, but all of the samples obtained by mixing the ESO and the PLLA had both good deformability and good recovery ratio as in the case where the PCL having Mn=80000 was used (Example 1). It should be noted that when using only the ESO, the film could not be molded into a loop-like shape.

### Example 11

An ESO and a bisphenol A diglycidyl ether (BPAEP) (Epikote® 828, Japan Epoxy Resins Co., Ltd.) were used as network polymers, and a PCL (Mn=80000) was used as a linear polymer. These polymers were mixed well in various ratios indicated in Table 6 below at room temperature together with 200 parts by weight of chloroform. Then, 1 part by weight (10 μL with respect to 1.0 g of the ESO) of an acid catalyst (San-Aid SI-100L) was added to and further mixed well with the mixtures. The resultant mixtures were poured into 44 mm×5 mm×1 mm fluoroplastic molds and heat-treated at 150° C. for 2 hours to obtain flat plate-like samples (molded shape) having a thickness of about 1 mm.

TABLE 6
Resin composition (part by weight)

| ESO | BPAEP | PCL |
|---|---|---|
| 100 | 0 | 0 |
| 50 | 50 | 0 |
| 50 | 0 | 50 |
| 25 | 25 | 50 |

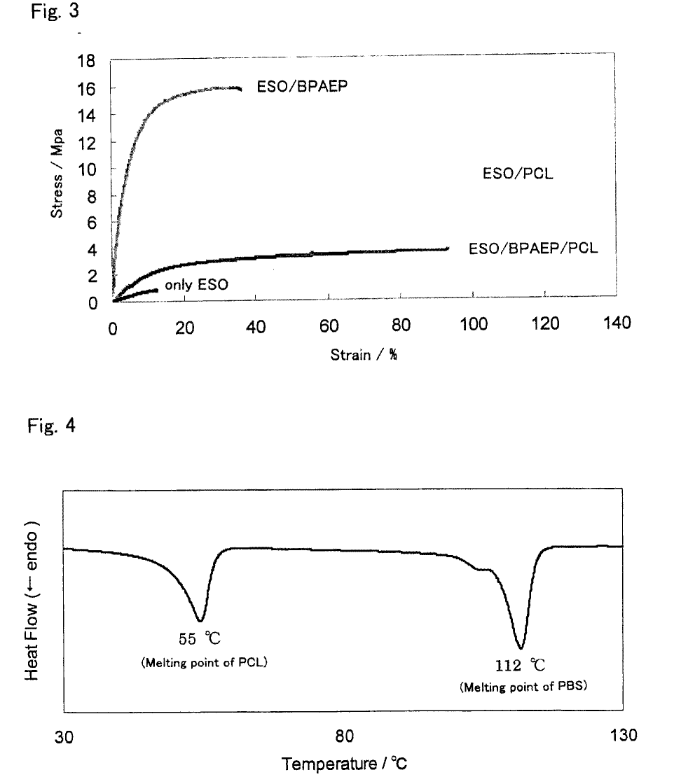

Each of the obtained samples was subjected to a tension test. The results are shown in FIG. 3. Both the breaking stress and the breaking strain of the ESO/BPAEP were markedly improved as compared with those of the ESO alone. On the other hand, the ESO/BPAEP/PCL had a decreased breaking stress but an improved breaking strain as compared with the ESO/BPAEP, and the strength of the ESO/BPAEP/PCL was similar to that of the ESO/PCL.

### Example 12

First, 25 parts by weight of an ESO, 25 parts by weight of a BPAEP, 50 parts by weight of a PCL (Mn=80000), and 200 parts by weight of chloroform were mixed well at room temperature, and 1 part by weight of an acid catalyst (San-Aid SI-100L) was added to and further mixed well with this mixture. The resultant mixture was poured into a large Teflon® mold, and chloroform was evaporated. Thereafter, a film thus formed was detached from the Teflon® mold and cut to a size of 67 mm×5 mm (thickness: 1 mm). This film was wrapped around a cylindrical glass tube and heated at 150° C. for 2 hours to obtain a helical sample (molded shape).

Then, since the obtained helical sample had a phase transition temperature of 60° C., which is the melting point of the PCL, this sample was warmed to 80° C., so that the helix was opened until the sample was deformed into a flat plate-like shape. When this deformed sample was rapidly cooled to room temperature, the sample was set to the flat plate-like shape (deformed shape). Then, when this flat plate-like sample was soaked in hot water at 80° C., the sample recovered the original helical shape.

### Example 13

First, 25 parts by weight of an ESO, 25 parts by weight of a BPAEP, 50 parts by weight of a PVC (molecular weight of 80000) were mixed well at room temperature, and 1 part by weight of an acid catalyst (San-Aid SI-100L) was added to and further mixed well with this mixture. The resultant mixture was poured into a 44 mm×5 mm×1 mm fluoroplastic mold and heat-treated at 150° C. for 2 hours to obtain a flat plate-like sample (molded shape) having a thickness of about 1 mm.

Then, since the obtained flat plate-like sample had a phase transition temperature of 60° C., which is the glass transition temperature of the PVC, this sample was warmed to 80° C., helically-wrapped around a glass rod having an outer circumferential length of about 20 mm about twice, and rapidly cooled to room temperature. As a result, the sample was deformed into a helical shape (deformed shape). Then, when this helical sample was soaked in hot water at 100° C., the sample recovered the original, flat plate-like shape.

### Example 14

First, 50 parts by weight of a BPAEP, 50 parts by weight of a PVC (molecular weight of 80000), and 200 parts by weight of chloroform were mixed well at room temperature, and 1 part by weight of an acid catalyst (San-Aid SI-100L) was added to and further mixed well with this mixture. The resultant mixture was poured into a large Teflon® mold, and chloroform was evaporated. Thereafter, a film thus formed was detached from the Teflon® mold and cut to a size of 67 mm×5 mm (thickness: 1 mm). This film was wrapped around a cylindrical glass tube and heated at 150° C. for 2 hours to obtain a helical sample (molded shape).

Then, since the obtained sample had a phase transition temperature of 80° C., which is the glass transition temperature of the PVC, this sample was warmed to 100° C., and the helix was opened until the sample was deformed into a flat plate-like shape. When this deformed sample was rapidly cooled to room temperature, the sample was set to the flat plate-like shape (deformed shape). Then, when this flat plate-like sample was soaked in hot water at 100° C., the sample returned to the original, helical shape.

### Example 15

First, 50 parts by weight of a BPAEP and 50 parts by weight of a PCL (Mn=80000) were mixed well at room temperature, and 1 part by weight of an acid catalyst (San-Aid SI-100L) was added to and further mixed well with this mixture. The resultant mixture was poured into a 44 mm×5 mm×1 mm fluoroplastic mold and heat-treated at 150° C. for 2 hours to obtain a flat plate-like sample (molded shape) having a thickness of about 1 mm.

Then, since the obtained flat plate-like sample had a phase transition temperature of 80° C., which is the glass transition temperature of the PVC, this flat plate-like sample was warmed to 80° C., helically-wrapped twice around a glass rod having an outer circumferential length of about 20 mm, and rapidly cooled to room temperature to obtain a helical sample. Then, when this helical sample was soaked in hot water at 80° C., the sample returned to the original, flat plate-like shape.

### Example 16

First, 50 parts by weight of an ESO, 50 parts by weight of a PCL (Mn=80000), and 50 parts by weight of a poly(butylene succinate) (PBS) were mixed well at room temperature, and 1 part by weight of an acid catalyst (San-Aid SI-100L) was added to and further mixed well with this mixture. The resultant mixture was poured into a 44 mm×5 mm×1 mm fluoroplastic mold and heat-treated at 150° C. for 2 hours to obtain a flat plate-like sample (molded shape) having a thickness of about 1 mm.

This sample was subjected to differential scanning calorimetry (DSC) (EXSTAR6000: Seiko Instruments Inc.). The sample was first heated from room temperature to 150° C. at a rate of 10° C./minute, and then maintained for 10 minutes in order to sufficiently melt crystals thereof. Then, the sample was cooled to −30° C. at a rate of 10° C./minute and was thus sufficiently crystallized. This sample was heated again to 150° C. at a rate of 10° C./minute.

FIG. 4 shows the results of the second scanning. Endothermic peaks due to melting of the PCL and the PBS appeared near 55° C. and near 112° C., respectively. This indicates that both the PCL and the PBS maintain their respective crystalline structures even in the composite material. It can be considered that the ESO/PCL/PBS can exert a two-stage shape memory function using the phase transition behavior of the PCL and the PBS.

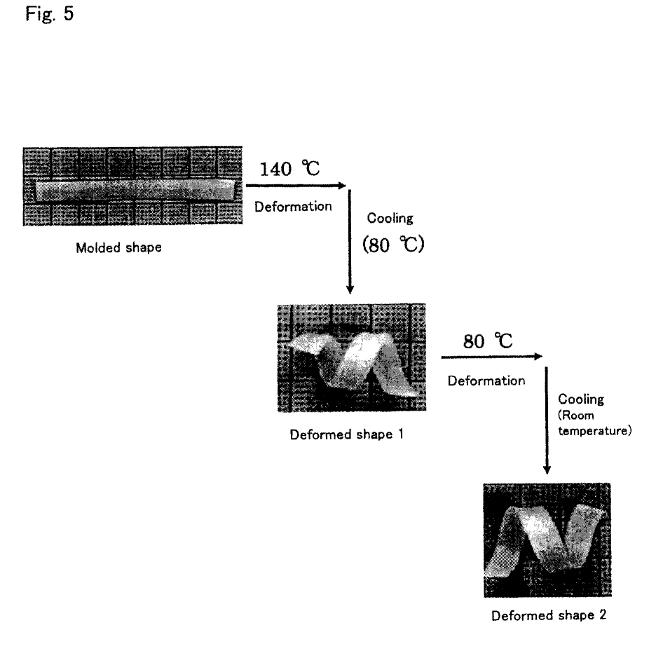

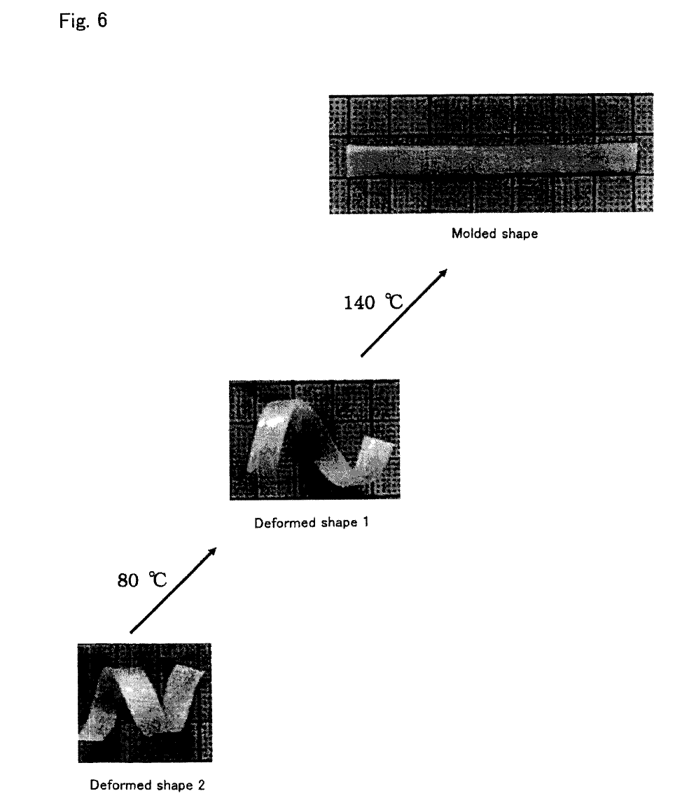

Thus, a shape memory process (FIG. 5) and a shape recovery process (FIG. 6) of this flat plate-like ESO/PCL/PBS were examined.

The phase transition temperatures are 60° C., which is the melting point of the PCL, and 120° C., which is the melting point of the PBS. Accordingly, the flat plate-like sample (molded shape) was first heated to 140° C., that is, above the melting point of the PBS, and deformed into a left-handed helical shape (deformed shape 1), as shown in FIG. 5. Then, when this sample was cooled to 80° C., that is, below the melting point of the PBS and above the melting point of the PCL, to crystallize only the PBS, the sample maintained the helical shape (deformed shape 1). Furthermore, when the sample was deformed into a right-handed helical shape (deformed shape 2) at that temperature and cooled to room temperature to crystallize the PCL, the sample maintained the shape (deformed shape 2).

Next, as shown in FIG. 6, when the sample having the right-handed helical shape (deformed shape 2) was heated to 80° C., the sample recovered to the left-handed helical shape (deformed shape 1). Subsequently, when heated to 120° C., the sample recovered to the flat plate-like shape (molded shape).

### Example 17

First, 50 parts by weight of an ESO, 50 parts by weight of a PCL (Mn=80000), 50 parts by weight of a PVC (molecular weight of 80000), and 200 parts by weight of chloroform were mixed well at room temperature, and 1 part by weight of an acid catalyst (San-Aid SI-100L) was added to and further mixed well with this mixture. The resultant mixture was poured into a large Teflon® mold, and chloroform was evaporated. Thereafter, a film thus formed was detached from the Teflon® mold and cut to a size of 67 mm×5 mm (thickness: 1 mm). This film was wrapped around a cylindrical glass tube and heated at 150° C. for 2 hours to obtain a helical sample (molded shape).

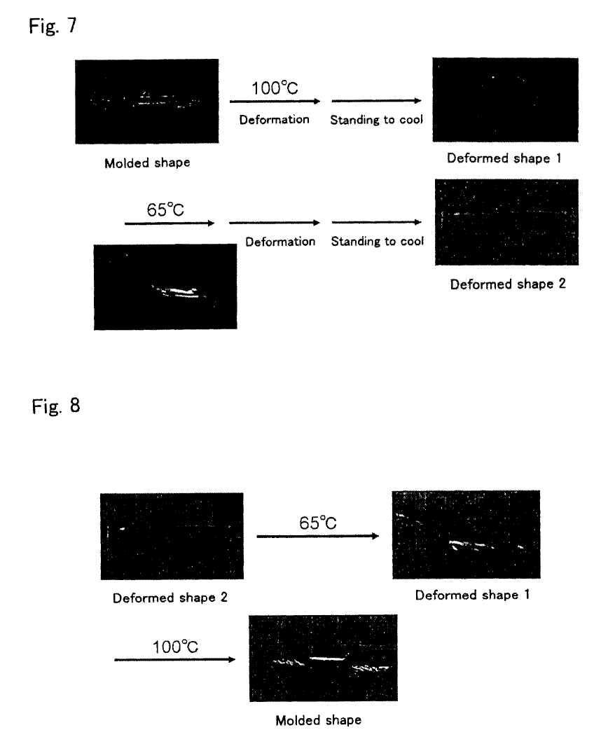

The phase transition temperatures are 60° C. that is the melting point of the PCL and 80° C. that is the glass transition temperature of the PVC. Accordingly, the sample was first heated to 100° C., that is, above the glass transition temperature of the PVC, 80° C., and wrapped around a glass rod having an outer circumferential length of 44 mm, and thus deformed into a loop-like sample (deformed shape 1), as shown in FIG. 7. Then, when this sample was cooled to 65° C., that is, above the melting point of the PCL and below the glass transition temperature of the PVC, the sample maintained the shape. Furthermore, when the loop was opened at that temperature until the sample was deformed into a flat plate-like shape (deformed shape 2), and this deformed sample was cooled to room temperature, the sample maintained the shape (deformed shape 2).

Next, as shown in FIG. 8, when the flat plate-like sample (deformed shape 2) was heated to 65° C., the sample recovered to a loose helical shape, and when further heated to 100° C., the sample recovered to the helical shape (molded shape).

### Example 18

First, 50 parts by weight of an ESO, 50 parts by weight of a PCL (Mn=80000), 50 parts by weight or 100 parts by weight of a PVC (molecular weight of 80000), and 200 parts by weight of chloroform were mixed well at room temperature, and 1 part by weight of an acid catalyst (San-Aid SI-100L) was added to and further mixed well with these mixtures. The resultant mixtures were poured into large Teflon® molds, and chloroform was evaporated. Thereafter, films thus formed were detached from the Teflon® molds and cut to a size of 67 mm×5 mm (thickness: 1 mm). These films were respectively wrapped around cylindrical glass tubes and heated at 150° C. for 2 hours, and thus a loop-like sample (molded shape) of each was obtained.

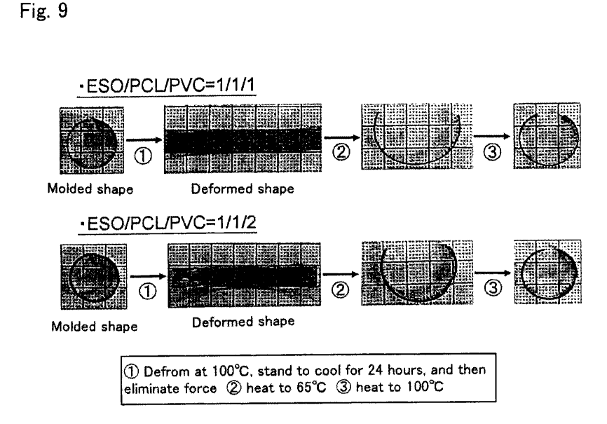

Then, as shown in FIG. 9, the loop-like samples were deformed at 100° C. by applying a force to the samples so as to open the loops. The samples were allowed to stand to cool for 24 hours, and thereafter, when the force applied thereto was eliminated, both of the samples substantially maintained flat plate-like shapes (deformed shapes). Then, when the samples were heated to 65° C., the samples recovered to curved shapes, and when further heated to 100° C., the samples recovered to the loop-like, original shapes.

### INDUSTRIAL APPLICABILITY

According to the present invention, a shape memory resin is provided in which an amorphous network polymer is used as a matrix and a thermoplastic polymer chain is fixed in this matrix at a molecular level. With this shape memory resin, the shape memory function can be exerted by using as an output a macroscopic change in the form of the phase transition polymer in the network. Therefore, the material properties can be freely adjusted in accordance with the intended purpose, and so the present invention can be easily applied to combinations of a wide range of resins. Moreover, the shape memory resin of the present invention can be produced by a very simple method in which a thermoplastic polymer is dissolved in a network polymer precursor (e.g., an epoxy compound), and curing is performed at a temperature equal to or above the phase transition temperature of the thermoplastic polymer. This reduces the production cost. Furthermore, for example, epoxides of natural fats and oils, which are receiving attention as renewable resources, can be effectively used as network polymer precursors in the present invention.

1. A shape memory resin comprising a network polymer and a thermoplastic polymer,
wherein the thermoplastic polymer has compatibility with a network polymer precursor and is dispersed in the network polymer.

2. The shape memory resin of claim 1, wherein the network polymer precursor is an epoxy compound.

3. The shape memory resin of claim 2, wherein the epoxy compound is at least one selected from the group consisting of an epoxidized fat or oil and an epoxy resin.

4. The shape memory resin of claim 3, wherein the epoxidized fat or oil is at least one selected from the group consisting of epoxidized soybean oil, epoxidized linseed oil, and epoxidized palm oil, and the epoxy resin is a bisphenol A type epoxy resin.

5. The shape memory resin of claim 1, wherein the thermoplastic polymer is at least one selected from the group consisting of polycaprolactone, polyvinyl chloride, polylactic acid, and poly(butylene succinate).

6. The shape memory resin of claim 1, wherein the glass transition temperature or the melting point of the thermoplastic polymer is different from the glass transition temperature of the network polymer by at least 20° C.

7. A method for producing a shape memory resin, comprising:
dissolving a thermoplastic polymer in a network polymer precursor to obtain a mixture; and
adding a hardener to the mixture to cross-link the network polymer precursor,
wherein the thermoplastic polymer has compatibility with the network polymer precursor.

8. The method of claim 7, wherein the network polymer precursor is an epoxy compound.

9. The method of claim 8, wherein the epoxy compound is at least one selected from the group consisting of an epoxidized fat or oil and an epoxy resin.

10. The method of claim 9, wherein the epoxidized fat or oil is at least one selected from the group consisting of epoxidized soybean oil, epoxidized linseed oil, and epoxidized palm oil, and the epoxy resin is a bisphenol A type epoxy resin.

11. The method of claim 7, wherein the thermoplastic polymer is at least one selected from the group consisting of polycaprolactone, polyvinyl chloride, polylactic acid, and poly(butylene succinate).

12. The method of claim 7, wherein the glass transition temperature or the melting point of the thermoplastic polymer is different from the glass transition temperature of the network polymer by at least 20° C.
